(19) United States
(12) Patent Application Publication
(10) Pub. No.: US 2009/0203323 A1
(43) Pub. Date: Aug. 13, 2009

(54) UPLINK CONTROL SIGNALING IN A COMMUNICATION SYSTEM

(75) Inventors: Rapeepat Ratasuk, Hoffman Estates, IL (US); Brian K. Classon, Palatine, IL (US); Amitabha Ghosh, Buffalo Grove, IL (US); Robert T. Love, Barrington, IL (US); Vijay Nangia, Algonquin, IL (US); Weimin Xiao, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/030,323

(22) Filed: Feb. 13, 2008

(51) Int. Cl. H04B 7/00; H04J 1/00

(52) U.S. Cl. 455/68; 370/343

(57) ABSTRACT

A system and method for uplink control signaling in a communication system includes a step of transmitting (200) the uplink control signaling in a frequency resource of the communication system reserved for random access. In particular, this step (200) can include allowing (202) the Physical Uplink Control Channel (PUCCH) to coexist with the Physical Random Access CHannel (PRACH) and transmitting (204) only channels which do not require Acknowledged/Negative Acknowledged (ACK/NACK) transmission.

### TECHNICAL FIELD OF THE INVENTION

This invention relates generally to wireless communication systems and more particularly to uplink control signaling in a communication system.

### BACKGROUND OF THE INVENTION

Various communications protocols are known in the art. For example, the Third Generation Partnership Project (3GPP) has been working towards developing a number of protocols for use with a wireless communication path. The original scope of 3GPP was to produce globally applicable technical specifications and technical reports for a 3rd generation mobile system based on evolved Global System for Mobile communication (GSM) core networks and the radio access technologies that they support, such as Evolved Universal Terrestrial Radio Access (EUTRA) including both Frequency Division Duplex (FDD) and Time Division Duplex (TDD) modes. 3GPP's scope was subsequently amended to include the maintenance and development of GSM technical specifications and technical reports including evolved radio access technologies (e.g. General Packet Radio Service (GPRS) and Enhanced Data rates for GSM Evolution (EDGE)).

Presently, EUTRA calls for a random access channel (RACH) protocol and in particular a physical random access procedure requiring reserved resources for RACH access. The RACH channel is used for initial access, handover, and synchronization establishment and maintenance to the network. This 3GPP UMTS specification permits an overall procedure that allows for various protocol/operational states to suit varying degrees of needed, anticipated, and/or desired operational activity for transmission of data packets. Unfortunately, in the proposed Long Term Evolution (LTE) 1.4 MHz frequency bandwidth systems, the RACH occupies all the uplink bandwidth and therefore no other uplink channels can be transmitted in the sub-frame. In particular, an uplink (UL) Acknowledge or Negative Acknowledge (ACK/NACK) cannot be transmitted when the RACH occurs, which impacts downlink (DL) data transmission.

Referring to FIG. 1, in the proposed LTE 1.4 MHz system the physical RACH (PRACH) occupies six Resource Blocks (RB0 through RB5), where each RB equals a 180 kHz frequency band by N OFDM symbols in time where N=7 for the normal cyclic prefix frame structure and N=6 for the extended cyclic prefix frame structure. Unfortunately, six RBs is also the total number of RBs available for 1.4 MHz system bandwidth. As a result, when the PRACH occurs, no orthogonal uplink transmission is possible. This is an issue for the ACK/NACK since this information is needed to support DL transmission. Specifically, the main issue is that the enhanced Node B (eNB) may not be able to transmit data on the physical downlink shared channel (PDSCH) of the associated downlink sub-frame since the ACK/NACK cannot be transmitted on the uplink. Several solutions to this problem have been proposed. In a first solution, the PRACH is transmitted on four or five RBs only. This requires a change to the RACH parameters for the 1.4 MHz while keeping the higher bandwidth LTE systems with a RACH of size six RBs, which in undesirable. In addition, if the PRACH bandwidth is reduced to five RBs, then physical uplink control channel (PUCCH) slot-hopping is not possible, resulting in some diversity loss for the PUCCH. Also, this PUCCH structure will be different which requires addition resource to implement and test. If the PRACH bandwidth is reduced to four RBs, then there is no change required for the PUCCH structure. However, in this case, the accuracy of the timing measurement from RACH transmission will be severely degraded. This is especially important since one-step synchronization process is used in EUTRA.

A second solution proposes to increase the number of RBs for the 1.4 MHz system to 7 or 8 RBs which will require extensive analysis by radio access network group. In addition, this may have possible out-of-band emission issues.

In a third solution, the eNB transmits only common channels. This solution requires transmission of common channels such as the broadcast channel (BCH) or the paging channel (PCH) that do not require an acknowledgement. In addition, this option may be attractive for multimedia broadcast services (i.e. MBSFN) where ACK/NACK is not required. However, restricting the downlink transmission to only common control channels will result in a waste of resource and impose further constraint on when these channels (or when the PRACH) may be transmitted. For example, this may prevent different sectors of the same base station from staggering RACH occurrence in time in order to reduce RACH processing and complexity at the base station.

What is needed is a technique for handling ACK/NACK in the case of PRACH transmissions in the LTE 1.4 MHz bandwidth system. It would also be of benefit to provide a unified approach that is applicable across all the different bandwidth LTE systems, and does not require a significant change of the PRACH parameters as in the prior art solutions.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 illustrates an existing PRACH sub-frame structure for a LTE 1.4 MHz bandwidth system;

FIG. 2 illustrates a sub-frame structure for a LTE 1.4 MHz bandwidth system, in accordance with a first embodiment of the present invention;

FIG. 3 illustrates a flow diagram for a LTE 1.4 MHz bandwidth system, in accordance with a second embodiment of the present invention;

FIG. 4 illustrates various sub-frame structures for a LTE 1.4 MHz bandwidth system, in accordance with a third embodiment of the present invention;

FIG. 5 illustrates a flow chart for a method, in accordance with the first embodiment of the present invention;

FIG. 6 illustrates a flow chart for a method, in accordance with the second embodiment of the present invention; and

FIG. 7 illustrates a flow chart for a method, in accordance with the third embodiment of the present invention.

Skilled artisans will appreciate that common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENT

The present invention provides a technique for handling uplink control messaging in the case of physical random access channel (PRACH) transmissions in the Long Term Evolution (LTE) 1.4 MHz bandwidth system. The present invention also provides a unified approach that is applicable across all the different bandwidth LTE systems, and does not require a change of the PRACH parameters, as will be detailed below for three particular embodiments.

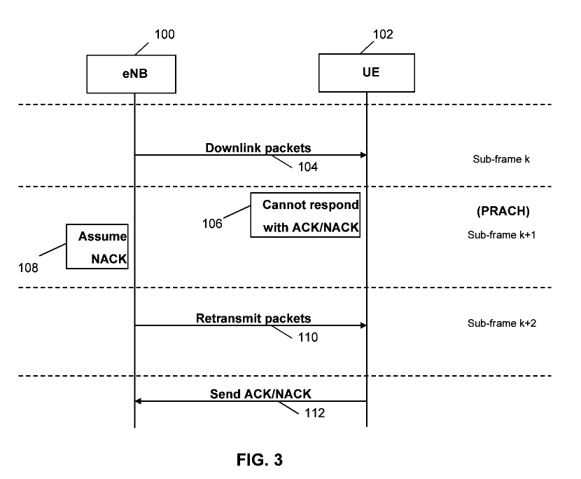

Referring to FIG. 2, in a first embodiment, the present invention allows physical uplink control channel (PUCCH) resources to coexist with the PRACH. In other words, the PUCCH resource is also part of the PRACH. As shown, a single PUCCH resource block (RB0) coexists with a PRACH resource block in a first slot of sub-frame k+1, and/or a PUCCH resource block (RB5) coexists with a PRACH resource block in a last slot of sub-frame k+1 (i.e. the band edges). Of course, other or more RB/slot combinations could be used also. The present invention allows uplink (UL) control signaling, such as ACK/NACKs, on at least one PUCCH even though sometimes there could be collisions with coinciding PRACH preamble transmissions.

To minimize interference, the eNB may prohibit transmission, such as from user equipment for example, of some uplink control signalling such as Channel Quality Indicator (CQI), Scheduling Request Indicator (SRI), a Precoding Matrix Indicator (PMI) in the uplink subframe containing the PRACH, or an acknowledgement message. These control signalling are then transmitted at the next reporting instance as long as that sub-frame is not a PRACH sub-frame.

Although an ACK/NACK transmission and a RACH preamble could interfere with each other, the enhanced Node B (eNB) can manage downlink (DL) data transmission to minimize this. As for interference, it is expected that the RACH load will be low, since it is typical that there is zero or one RACH transmission per PRACH. In addition, up to eighteen ACK/NACK messages can be multiplexed into one PUCCH resource block, although typically only one to three ACK/NACK messages will be transmitted. Therefore, interference will not be present at all times. Even so, allowing the PUCCH to co-exist with the RACH will increase False Alarm rates for both PUCCH and RACH, so eNB should minimize the impact of this interference. For example, the eNB can schedule common channels that do not require an ACK/NACK response. Alternatively, the eNB can schedule the physical downlink shared channel (PDSCH) to minimize ACK/NACK occurrences when the PUCCH resource for an ACK/NACK message would coincide with the PRACH sub-frame. For example, the eNB may schedule only one user on the PDSCH so as to minimize the number of ACK/NACK message and therefore minimize interference with possible RACH transmission. Additionally, the eNB may be aware of pending RACH transmission using dedicated preambles and therefore may abstain from scheduling any data transmission on the PDSCH.

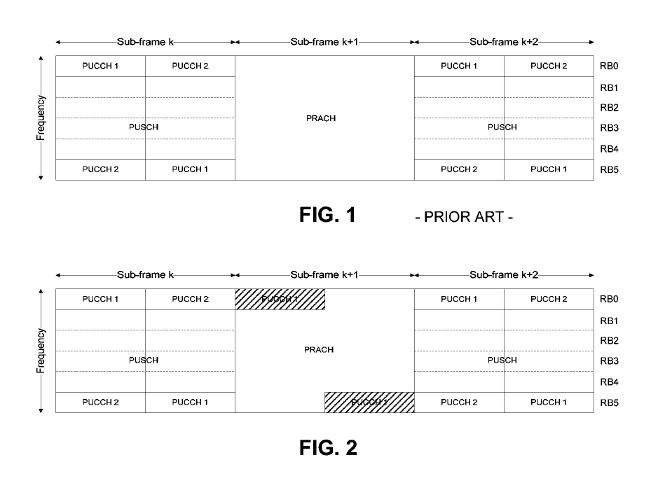

Referring to FIG. 3, in a second embodiment, the present invention has the eNB 100 assume NACKs on PDSCH transmissions to a UE 102. For example, (and referring back to FIG. 1 and to FIG. 3), if a downlink message 104 is successfully received by a UE in sub-frame k, that UE could not respond 106 with an ACK/NACK transmission in sub-frame k+1 since that sub-frame is completely occupied by the PRACH. Therefore, without modification to the existing sub-frame structure, the eNB could just assume NACKs 108 on all PDSCH transmissions 104 in sub-frame k, and retransmissions 110 will be required in sub-frame k+2. The UE 102 could then send a normal ACK/NACK message 112 in a next sub-frame as long as that next sub-frame is not a PRACH sub-frame. In the above example, system throughput will be reduced if the packets were successfully received by the UEs the first time. However, eNB can schedule more aggressively in this situation, for example by transmitting more data to the UE than it can successfully received in this sub-frame, so that there is only a marginal impact on overall system throughput. In addition, for persistently scheduled users, the eNB can instead adjust the power, such as during a sub-frame before a PRACH sub-frame, to improve the likelihood that any packets transmitted to a UE in sub-frame k are properly received by the UE. For delay sensitive traffic, there may be some delay impact which can also be overcome through intelligent scheduling. Note that this method will require some restriction in the DL:UL split in a TDD deployment since, for example, a 8 DL:1 UL split cannot be supported from a timing perspective.

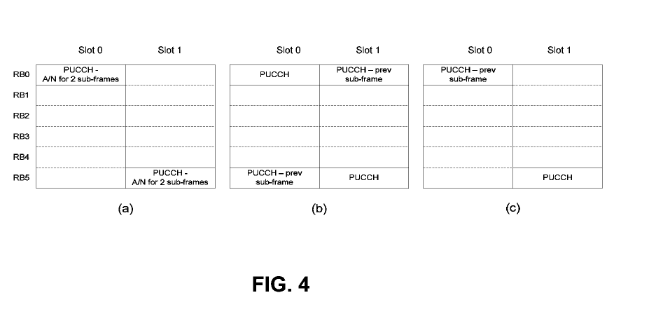

Referring to FIG. 4, in a third embodiment, the present invention delays the ACK/NACK to the next UL available sub-frame without the PRACH which may be implemented in several ways as shown. For example, an ACK/NACK message that would have been sent to the eNB by a UE during sub-frame k+1, but is blocked by the PRACH (as in FIG. 1), could be delayed to sub-frame k+2. Although this solution does not require a change in the PRACH parameters, the round trip delay is changed since the ACK/NACK will be available one sub-frame later. However, with asynchronous HARQ in the DL, timing is not expected to be an issue. On the other hand, it should be noted that this solution will require some restriction in the DL:UL split in a TDD deployment similar to the second embodiment.

FIG. 4 shows three different multiplexing options for the ACK/NACKs in the next uplink sub-frame, in accordance with this third embodiment. One option is to use a multi-frame ACK/NACK structure similar to what may be adopted for TDD or Half-Duplex FDD to address the previous and current sub-frames, as shown in FIG. 4(a). In this first option, one ACK/NACK message can address two DL sub-frames in one resource block. The second option is to define an additional PUCCH resource region that is associated with the previous DL sub-frame, as shown in FIG. 4(b). If additional PUCCH region is defined, however, scheduling restriction will be needed to ensure that a UE is not scheduled to receive data in both DL sub-frames since it cannot transmit ACK/NACK on both PUCCHs simultaneously. A third option may be to transmit an ACK/NACK message in only a portion of the control channel, i.e. transmit an ACK/NACK message for an existing sub-frame downloaded packet in one slot and the ACK/NACK message for a previous sub-frame downloaded packet in another slot so that ACK/NACK messages for both DL sub-frames can fit in one control region, as shown in FIG. 4(c). This option may require that only users with relatively good channel conditions are scheduled in those corresponding downlink sub-frames.

In the examples shown above, the control channels are shown in band edges in each control region. However, it should be recognized that the eNB and user equipment (UE) can choose the best available resource blocks for their control transmissions.

Referring to FIG. 5, the present invention also provides a method for uplink control signaling during random access in a communication system, in accordance with a first embodiment of the present invention. The method includes a step 200 of transmitting the uplink control signaling in a frequency resource of the communication system reserved for random access. In particular, this includes allowing 202 the Physical Uplink Control Channel (PUCCH) to coexist with the Physical Random Access CHannel (PRACH). Optionally, this can include transmitting 204 only channels which do not require Acknowledged/Negative Acknowledged (ACK/NACK) transmission in order to reduce interference between the PUCCH and the PRACH.

An optional step 206 includes scheduling the physical downlink shared channel (PDSCH) to minimize ACK/NACK occurrences when the PUCCH resource coincides with the PRACH sub-frame

In the above embodiment, the uplink control signaling comprises at least one of the group of, an acknowledgement, a channel quality indicator, a precoding matrix indicator, and a scheduling request indicator. In addition, the communication system of this embodiment can be a Frequency Division Duplex (FDD) system or a Time Division Duplex (TDD) system.

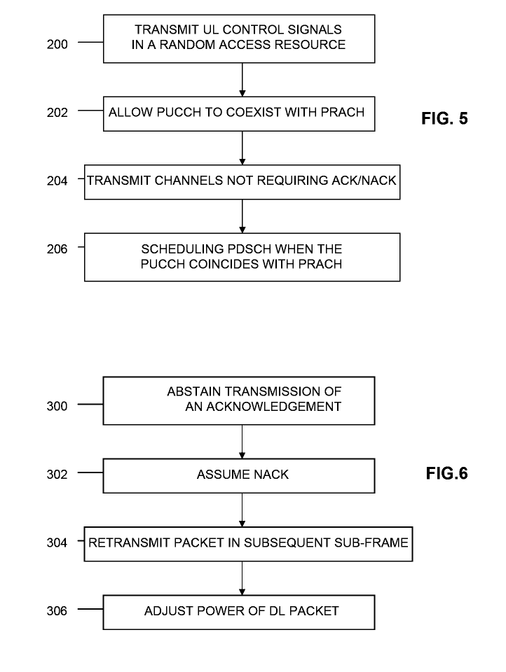

Referring to FIG. 6, the present invention also provides a method for uplink control signaling in a communication system, in accordance with a second embodiment of the present invention. This method includes a first step 300 of a UE abstaining from the transmission of an acknowledgement (i.e. either ACK or NACK) of a packet. A next step 302 includes the base station (eNode B) assuming that the packet was received in error (i.e. a NACK). A next step 304 includes the base station retransmitting the downlink packet in a subsequent sub-frame. A next step 306 includes adjusting the power of a download packet.

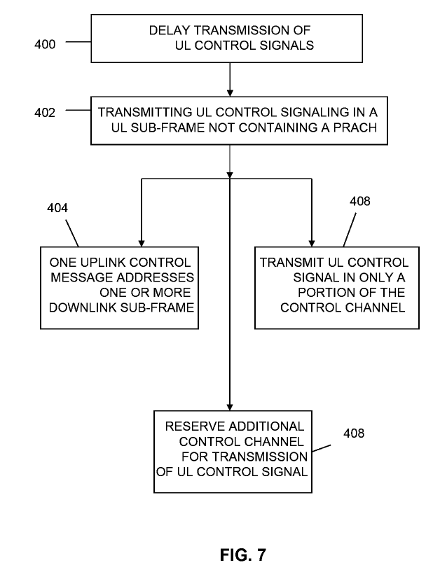

Referring to FIG. 7, the present invention also provides a method for uplink control signaling in a communication system, in accordance with a third embodiment of the present invention. The method includes a first step 400 of delaying transmission of the uplink control signaling. A next step 402 includes transmitting the delayed uplink control signaling in an uplink sub-frame not containing a physical random access channel.

In a first option of this third embodiment, the uplink control signaling comprises acknowledgments associated with at least one, and preferably two or more, downlink sub-frame. In particular, one acknowledgement (ACK/NACK) message can address one or more DL sub-frames in one control channel or resource block.

In a second option of this third embodiment, an additional control channel is reserved for transmission of uplink control signaling. In particular, an additional uplink control channel (e.g. PUCCH) or resource block is associated with a previous DL sub-frame.

In a third option of this third embodiment, the uplink control signaling is transmitted in only a portion of the control channel. In particular, this step includes transmitting an ACK/NACK message for an existing sub-frame downloaded packet in one slot and the ACK/NACK message for a previous sub-frame downloaded packet in another slot such that ACK/NACK messages for both DL sub-frames can fit in one control region.

The present invention provides the advantage of enhancing capacity of the E-UTRA system pursuant to the above embodiments. Notwithstanding the stated benefits, the embodiments described herein can be realized with only minimal changes to the relevant 3GPP, 3GPP2, and 802.16 standards. It will be understood that the terms and expressions used herein have the ordinary meaning as is accorded to such terms and expressions by persons skilled in the field of the invention as set forth above except where specific meanings have otherwise been set forth herein.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including use of hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

While the invention may be susceptible to various modifications and alternative forms, a specific embodiment has been shown by way of example in the drawings and has been described in detail herein. However, it should be understood that the invention is not intended to be limited to the particular forms disclosed, and can be applied equally well to any communication system that can use real-time services. Rather, the invention is to cover all modification, equivalents and alternatives falling within the scope of the invention as defined by the following appended claims.

What is claimed is:

1. A method for uplink control signaling in a communication system, the method comprising the step of:
transmitting the uplink control signaling in a frequency resource of the communication system reserved for random access.

2. The method of claim 1, wherein for downlink transmissions associated with the uplink control signalling further comprising the step of transmitting only downlink channels which do not require Acknowledged/Negative Acknowledged (ACK/NACK) transmission.

3. The method of claim 1, wherein the transmitting step includes allowing the Physical Uplink Control Channel (PUCCH) to coexist with the Physical Random Access CHannel (PRACH).

4. The method of claim 1, wherein the uplink control signaling comprises at least one of the group of; an acknowledgement, a channel quality indicator, a precoding matrix indicator, and a scheduling request indicator.

5. The method of claim 1, wherein the communication system is a Frequency Division Duplex system.

6. The method of claim 1, wherein the communication system is a Time Division Duplex system.

7. The method of claim 1, further comprising the step of prohibiting a user equipment from transmitting at least one of the group of, an acknowledgement, a channel quality indicator, a precoding matrix indicator, and a scheduling request indicator.

8. A method for providing uplink control signaling during random access, the method comprising the steps:
abstaining from the transmission of an acknowledgement of a downlink packet; and
a base station assuming that the downlink packet was received in error.

9. The method of claim 8, further comprising the step of the base station retransmitting the downlink packet in a subsequent sub-frame.

10. The method of claim 8, wherein further comprising the step of adjusting the power of a downlink packet.

11. A method for providing uplink control signaling in a communication system, the method comprising the steps of:
delaying transmission of the uplink control signaling; and
transmitting the delayed uplink control signaling in an uplink sub-frame not containing a physical random access channel.

12. The method of claim 11, wherein the uplink control signaling comprises of acknowledgments associated with at least one downlink sub-frame.

13. The method of claim 12, wherein one acknowledgment message can address at least one downlink sub-frames in one control channel.

14. The method of claim 11, wherein an additional control channel is reserved for transmission of uplink control signaling.

15. The method of claim 14, wherein an additional uplink control channel is associated with a previous downlink sub-frame.

16. The method of claim 11, wherein the uplink control signaling is transmitted in only a portion of the control channel.

17. The method of claim 16, wherein this step includes transmitting an acknowledgment message for an existing sub-frame packet in one slot and the acknowledgment message for a previous sub-frame packet in another slot such that acknowledgment messages for both downlink sub-frames can fit in one control region.

18. A communication system having uplink control signaling, the system comprising:
a frequency resource of the communication system reserved for random access; and
an enhanced Node B that transmits the uplink control signaling within the frequency resource.
